(19) United States
(12) Patent Application Publication
(10) Pub. No.: US 2024/0065928 A1
(43) Pub. Date: Feb. 29, 2024

(54) HUMAN BODY VIBRATING DEVICE

(71) Applicant: DAHO ENTERPRISE LLC, Davie, FL (US)

(72) Inventor: HILAY OR, PARDESS-HANA (IL)

(21) Appl. No.: 17/938,979

(22) Filed: Sep. 7, 2022

(30) Foreign Application Priority Data
Aug. 31, 2022 (EP) 22193340

(51) Int. Cl. A61H 19/00; A61H 23/00

(52) U.S. Cl. CPC A61H 19/34; A61H 23/004; A61H 2201/0192; A61H 2201/165; A61H 2205/087

(57) ABSTRACT

A human body vibrating device, including a package including at least a first portion including a sticker, and a vibrating element, vibration thereof for vibrating a second portion of the package, thereby the vibration of the second portion vibrates a portion of a user's body upon sticking the at least first portion of the package to the user's body and upon operating the vibrating element.

### CROSS-REFERENCE TO RELATED APPLICATIONS

This application claims the benefit of priority from European Patent Application No. 22193340 filed Aug. 31, 2022, the disclosure of which is incorporated herein by reference.

### TECHNICAL FIELD

The invention relates to the field of human body vibrating devices.

### BACKGROUND

Prior art human body vibrating devices lack true adjustment means.

There is a long felt need to provide a solution to the above-mentioned and other problems of the prior art.

### SUMMARY

In one aspect of the invention a human body vibrating device is provided, including a package including a sticker and a vibrating element.

### BRIEF DESCRIPTION OF THE DRAWINGS

Embodiments, features, and aspects of the invention are described herein in conjunction with the following drawings:

FIG. 1 is a side view of a human body vibrating device according to one embodiment.

FIG. 2 is a side sectional view of the human body vibrating device of FIG. 1.

FIG. 3 is a perspective schematic view of the human body vibrating device of FIG. 1, without its flexible wrap.

FIG. 4 is the side view of the human body vibrating device of FIG. 1, without its flexible wrap, connected to the user's body and pressing it.

FIG. 5 is the side view of FIG. 4 without pressing the user's body.

FIG. 6 is the side view of FIG. 5 at moderate bending of the metallic strap.

FIG. 7 is the side view of FIG. 5 at slight bending of the metallic strap.

FIG. 8 is the side view of FIG. 7 once the vibrating device draws the working region away from the user's body.

FIG. 9 is the side view of FIG. 4 upon inserting the vibrating device deep into the socket while the vibration presses the user's body.

FIG. 10 is the side view of FIG. 4 upon inserting the vibrating not deep into the socket while the vibration presses the user's body.

FIG. 11 is a front view of the human body vibrating device according to one embodiment.

FIG. 12 is the front view of the human body vibrating device of FIG. 11 stuck to the user's body.

FIG. 13 is the front view of FIG. 11 having a different shape.

FIG. 14 is the front view of FIG. 12 having a different shape.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out devices in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

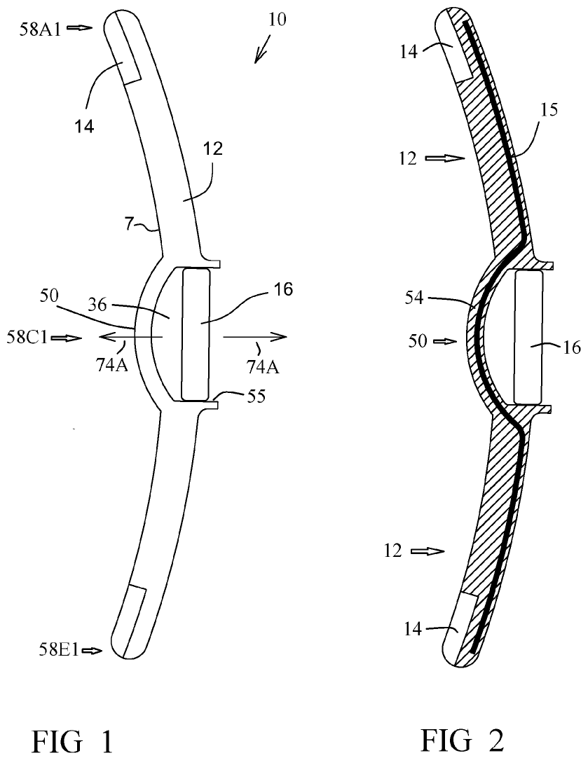

FIG. 1 is a side view of a human body vibrating device according to one embodiment.

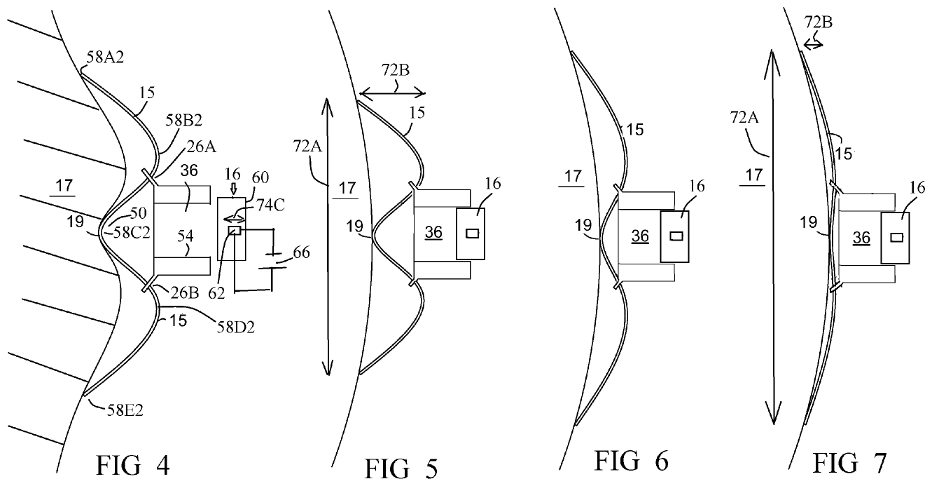

A human body vibrating device 10 according to one embodiment, includes a working region 50, for vibrating a portion 19 (FIG. 4) of the user's body 17 (FIG. 4); a socket 36 including internal walls 55; a vibrating element 16, for attaching socket 36, for vibrating working region 50 through socket 16; and flexible bands 12 for holding socket 36.

Bands 12 include stickers 14 for sticking portions of straps 12 to the user's body.

FIG. 2 is a side sectional view of the human body vibrating device of FIG. 1.

A bendable springy metallic strap 15 is disposed within working region 50 and flexible bands 14 therealong. Metallic strap 15 is springy and resilient for vibrating like in musical string instrument, as a function of its length.

Metallic strap 15 is wrapped by a flexible package 54 of working region and of bands 12.

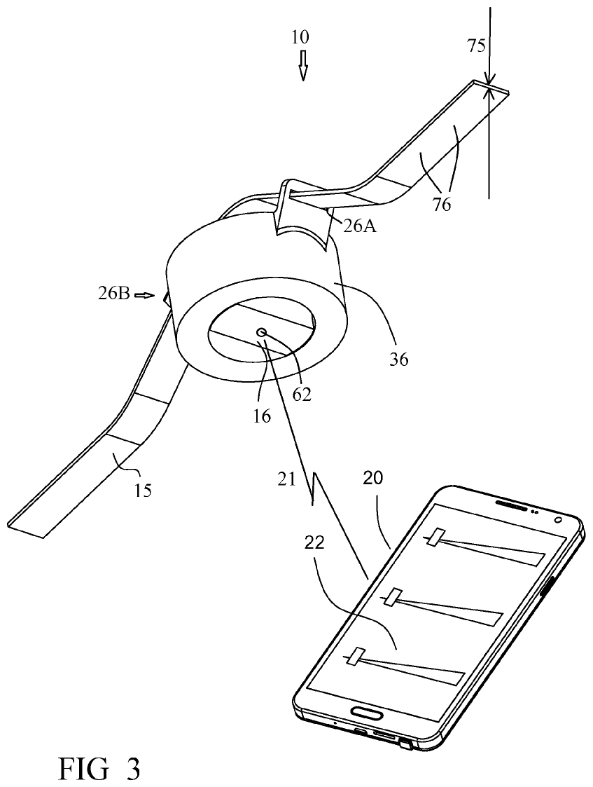

FIG. 3 is a perspective schematic view of the human body vibrating device of FIG. 1, without its flexible wrap.

Bendable metallic strap 15 (and bands 12 (FIG. 2)) is flat (76) and thin (75) and threaded through apertures 26A and 26B and are slidable in relation thereto. Apertures 26A and 26B are fixed to socket 36, thus bendable metallic strap 15 is slidable in relation to socket 36 and vibrating element 16.

FIG. 4 is the side view of the human body vibrating device of FIG. 1, without its flexible wrap, connected to the user's body and pressing it.

Metallic strap 15 is shaped to the shape of “W” letter, namely two ends 58A2,58E2 and center 58C2 of strap 15 are directed to the left (in the drawing); whereas the center 58B2 between end 58A2 and center 58C2, and the center 58D2 between end 58E2 and center 58C2 are directed to the right.

At use, ends 58A and 58E are attached (via flexible package 54 of FIG. 2) to the user's body 17, thus center 58C as well is directed to user's body 17, thus working region 50 being at center 58C, vibrates portion 19 of user's body 17.

Vibrating element 16 includes a weight 62 for being vibrated (vibration 74C) upon being powered by a battery 66, in relation to a package 60.

Package 60 of vibrating element 16 may resilient and wider than socket 36, for allowing the user to insert package 60 into socket 36 to a position for being held thereby, as shown in FIG. 3.

FIG. 5 is the side view of FIG. 4 without pressing the user's body.

FIG. 6 is the side view of FIG. 5 at moderate bending of the metallic strap.

FIG. 7 is the side view of FIG. 5 at slight bending of the metallic strap.

Metallic strap 15 allows the user to adjust the extent of the bending of metallic strap 15, such as from increased bending shown in FIG. 5, to moderate bending of FIG. 6, and to slight being of FIG. 7 by sliding metallic strap 15 in relation to socket 36 through apertures 26A and 26B.

The extent of the bending determines the parameters of the vibration applied by metallic strap 15. For example, the larger is the distance 72A between ends 58A2 and 58E2 of metallic strap 15 formed by the bending and determining the vibration string, the smaller is the frequency of its vibration (74A).

The adjustment of the extent of the bending of metallic strap 15 is the roughest adjustment, determining the range of the vibration.

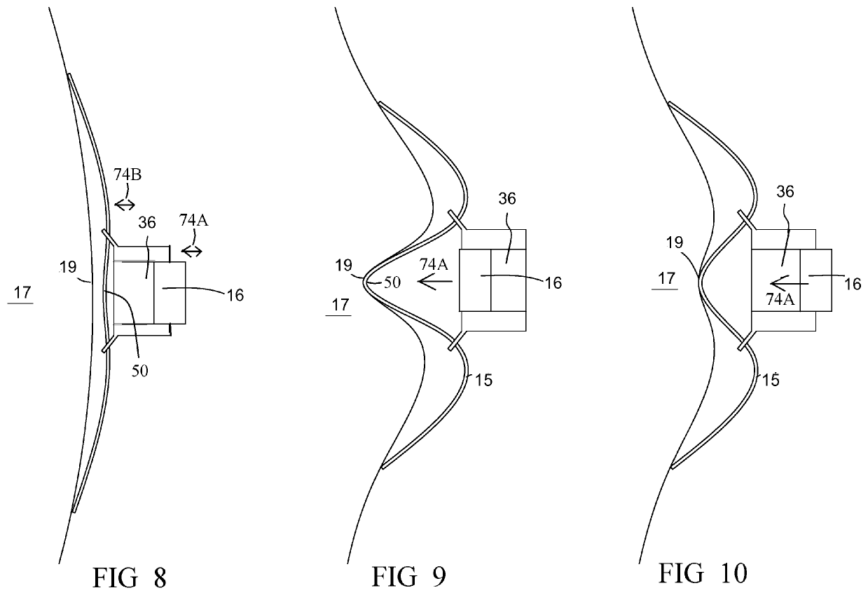

FIG. 8 is the side view of FIG. 7 once the vibrating device draws the working region away from the user's body.

Vibration 74A of vibrating element 16 vibrates (74B) working region (FIG. 7) towards user's body 17 and away therefrom (FIG. 8).

FIG. 9 is the side view of FIG. 4 upon inserting the vibrating device deep into the socket while the vibration presses the user's body.

The vibrating 74 may as well press working region 50 into the user's body.

FIG. 10 is the side view of FIG. 4 upon inserting the vibrating not deep into the socket while the vibration presses the user's body.

Increased resolution adjustment may be applied by adjusting the extent of the insertion of package 60 into socket 36, being the position of package 60 in relation to socket 36, while weight 62 vibrates.

Vibrating element 16 inserted deep into socket 36 of FIG. 9 has stronger force of vibration 74 than upon being inserted not deep into socket 36 of FIG. 10. Thus, vibrating element 16 inserted deep into socket 36 of FIG. 9 presses upon vibration 74 working region 50 deeper into the user's body 17.

Referring again to FIG. 3, a further increased resolution adjustment is by electronically adjusting (22) the vibration parameters, such as frequency and intensity produced by vibrating element 16, such as wirelessly (21) by a smartphone 20.

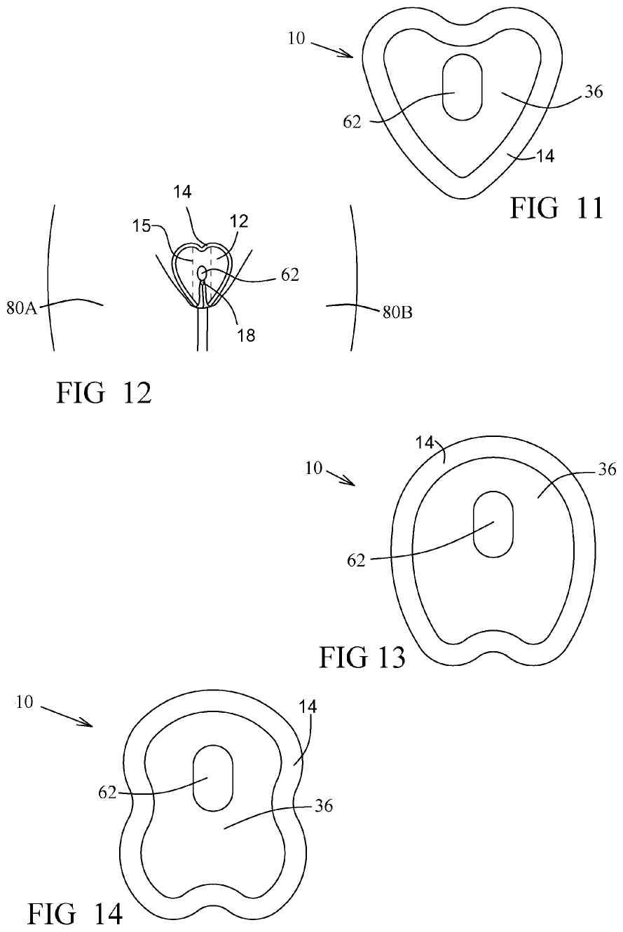

FIG. 11 is a front view of the human body vibrating device according to one embodiment.

FIG. 12 is the front view of the human body vibrating device of FIG. 11 stuck to the user's body.

Working region 50 (FIG. 1) of human body vibrating device 10 is preferably disposed adjacent to the clitoris 18 or female pubic region surrounding the vaginal area, for vibrating it.

FIG. 13 is the front view of FIG. 11 having a different shape.

FIG. 14 is the front view of FIG. 12 having a different shape.

Thus, in one aspect, the invention is directed to a human body vibrating device (10), including a package (54) including at least a first portion (58A1,58E1) including a sticker (14), and a vibrating element (16), vibration thereof (74A) for vibrating (74B) a second portion (58C) of the package (54), thereby the vibration (74B) of the second portion (58C) vibrates a portion (19) of a user's body (17) upon sticking the at least first portion (58A1,58E1) of the package (54) to the user's body (17) and upon operating the vibrating element (16).

The sticking of the at least first portion (58A1,58E1) of the package (54) to the user's body (17) may apply disposing the second portion (58C1) of the package (54) adjacent to the female pubic region surrounding a vaginal area (18).

The human body vibrating device may further include a flat (76), thin (75) and springy metallic strap (15) being packaged by the package (54), for being vibrated by the vibrating element (16).

The springy metallic strap (15) may be shaped to English “W” letter, and the at least first portion (58A1,58E1) of the package (54) packages a first end (58A2) and a second end (58E2) of the metallic strap (15) for directing thereof towards the user's body (17) upon sticking the at least first portion (58A1,58E1) to the user's body (17), and wherein the second portion (58C1) of the package (54) packages a center (58C2) of the metallic strap (15) being directed to the user's body (17), thereby a first region (58B2) between the first end (58A2) and the center (58C2) of the metallic strap (15), and a second region (58D2) between the second end (58E2) and the center (58C2) of the metallic strap (15), are directed away from the user's body (17) by the “W” shape, thereby the vibrating element (16) vibrates the center (58C2) of the metallic strap (15) being directed to the user's body (17).

The metallic strap (15) may be user bendable within the “W” shape thereof for maintaining the bent shape, thereby allowing the user to adjust length (72A) between the first (58A2) and second (58E2) ends of the metallic strap (15), thereby to adjust parameters of the vibration (74B) of the second portion (58C) of the package (54).

Position of the vibrating element (16) in relation to the package (54) may be user adjustable, thereby allowing the user to further adjust parameters of the vibration (74B) of the second portion (58C) of the package (54).

Parameters of the vibration (74A) of the vibrating element (16) are user adjustable, thereby allowing the user to further adjust parameters of the vibration (74B) of the second portion (58C) of the package (54).

The springy metallic strap (15) may be slidable in relation to the vibrating element (16).

In the figures and description herein, the following reference numerals (Reference Signs List) have been mentioned:
numeral 10 denotes the human body vibrating device according to one embodiment of the invention;
12: band;
14: sticker;
16: vibrating element;
17: user's body;
18: clitoris;
19: portion of user's body 17 being vibrated;
20: smartphone or other device for controlling vibrating element 16;
21: wireless transmission;
22: electronic adjusting;
26A,26B: apertures;
36: socket for holding vibrating element;
50: working region being vibrated by region 58C1;
54: flexible package;
55: internal wall of socket 36;
58A1,58C1,58E1: regions of package 54;
58A2,58B2,58C2,58D2,58E2: regions of metallic strap 15;
60: package of vibrating element 16;
62: weight of vibrating element 16;
66: battery;
72A: distance between ends 58A2 and 58E2 of metallic strap 15;
72B: distance of regions of metallic strap 15 determining the amplitude of the vibration;
74A: vibration of vibrating element 16;
74B: vibration of region 58C2 of metallic strap 15;
74C: vibration of weight 62;
75: thickness of metallic strap 15 being small;
76: flatness of metallic strap 15 prior to bending thereof;
80A,80B: user's legs;
The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A human body vibrating device, comprising:
a package comprising at least a first portion comprising a sticker; and
a vibrating element, vibration thereof for vibrating a second portion of said package,
thereby said vibration of said second portion vibrates a portion of a user's body upon sticking said at least first portion of said package to the user's body and upon operating said vibrating element.

2. The human body vibrating device according to claim 1, wherein said sticking said at least first portion of said package to the user's body comprises disposing said second portion of said package adjacent to a female pubic region surrounding a vaginal area.

3. The human body vibrating device according to claim 1, further comprising a flat, thin and springy metallic strap being packaged by said package, for being vibrated by said vibrating element.

4. The human body vibrating device according to claim 3, wherein said springy metallic strap is shaped to English “W” letter, and
wherein said at least first portion of said package packages a first end and a second end of said metallic strap for directing thereof towards said user's body upon sticking said at least first portion to the user's body, and
wherein said second portion of said package packages a center of said metallic strap being directed to said user's body,
thereby a first region between said first end and said center of said metallic strap, and a second region between said second end and said center of said metallic strap, are directed away from said user's body by said “W” shape,
thereby said vibrating element vibrates said center of said metallic strap being directed to said user's body.

5. The human body vibrating device according to claim 4, wherein said metallic strap is user bendable within said “W” shape thereof for maintaining the bent shape, thereby allowing the user to adjust length between said first and second ends of said metallic strap, thereby to adjust parameters of said vibration of said second portion of said package.

6. The human body vibrating device according to claim 1, wherein position of said vibrating element in relation to said package is user adjustable, thereby allowing the user to further adjust parameters of said vibration of said second portion of said package.

7. The human body vibrating device according to claim 1, wherein at least one parameter of said vibration of said vibrating element is user adjustable, thereby allowing the user to further adjust parameters of said vibration of said second portion of said package.

8. The human body vibrating device according to claim 1, wherein said springy metallic strap is slidable in relation to said vibrating element.
